(19) United States
(12) Patent Application Publication
(10) Pub. No.: US 2021/0191964 A1
(43) Pub. Date: Jun. 24, 2021

(54) METHOD, APPARATUS, AND COMPUTER-READABLE MEDIUM FOR GENERATING HEADLINES

(71) Applicant: Temnos, Inc., San Jose, CA (US)

(72) Inventor: Timothy A. Musgrove, Morgan Hill, CA (US)

(21) Appl. No.: 17/137,533

(22) Filed: Dec. 30, 2020

Related U.S. Application Data
(63) Continuation of application No. 14/284,370, filed on May 21, 2014, now abandoned.
(60) Provisional application No. 61/825,993, filed on May 21, 2013.

(51) Int. Cl. G06F 16/34; G06F 16/2457

(52) U.S. Cl. CPC G06F 16/345; G06F 16/24578

(57) ABSTRACT

An apparatus, computer-readable medium, and computer-implemented method for generating a headline includes identifying a content section of a document, selecting a sentence in the content section based at least in part on a determination that the sentence exhibits one or more characteristics correlated with headline performance, extracting a portion of the sentence based at least in part on a trigger attribute within the sentence, and generating the headline based at least in part on the portion of the sentence.

### RELATED APPLICATION DATA

This application claims priority to U.S. Provisional Application No. 61/825,993, filed May 21, 2013, the disclosure of which is hereby incorporated by reference in its entirety.

### BACKGROUND

Headlines are the first, and sometimes the only, opportunity to capture a user's attention. As a result, special time is spent in educating news writers on how to write headlines. This is often considered more art than science. Historically, the motivation for writing engaging headlines was to sell more newspapers—from a time when consumers would only glimpse a paper from inside a machine and decide whether to purchase based on the headline. Today, in the context of digital media, the rewards for writing engaging headlines translate into user clicks of the headlines within digital environments, such as web pages, mobile apps, Twitter streams, or discussion threads.

Content promoters, such as publishers, aggregators, content platform providers, and marketers, all wish for promoted content to have the most engaging (yet accurate) headlines possible. It has been shown that even though measures can be taken in advance to train staff to write better headlines, ultimately it is not possible to predict how well a headline will perform in terms of its click-through-rate (“CTR”) with a particular audience in a particular digital medium or venue.

Therefore, in order to find the best performing headline, a content promoter would have to hire writers or editors who are properly trained, and have them write several alternative headlines for each new piece of content. Then each of the alternative headlines would have to be rotated while tracking performance in order to determine which alternative headline yielded the highest CTR. For subsequent impressions or placements, the content promoter could then then use the “winning” headline(s).

This manual headline generation process would be slow and expensive. Trained writers would have to be hired to produce all of these headlines. Additionally, since digital content is syndicated and aggregated across different time zones around the clock, a content promoter would need such writers ready at every moment.

Unfortunately, there are currently no systems for automatically and effectively generating alternative headlines for content.

### BRIEF DESCRIPTION OF THE DRAWINGS

FIG. 1 illustrates a flowchart for generating a headline according to an exemplary embodiment.

FIG. 2 illustrates an example document according to an exemplary embodiment.

FIG. 3 illustrates a flowchart for selecting sentences in a content section of a document according to an exemplary embodiment.

FIG. 4 illustrates a flowchart for extracting a portion of a sentence according to an exemplary embodiment.

FIG. 5 illustrates an example of the sentence portion extraction process according to an exemplary embodiment.

FIG. 6 illustrates a flowchart for generating a headline from a sentence portion according to an exemplary embodiment.

FIG. 7 illustrates an example of the headline generation process according to an exemplary embodiment.

FIG. 8 illustrates an exemplary computing environment that can be used to carry out the method for generating a headline according to an exemplary embodiment.

### DETAILED DESCRIPTION

While methods, apparatuses, and computer-readable media are described herein by way of examples and embodiments, those skilled in the art recognize that methods, apparatuses, and computer-readable media for generating headlines are not limited to the embodiments or drawings described. It should be understood that the drawings and description are not intended to be limited to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to) rather than the mandatory sense (i.e., meaning must). Similarly, the words “include,” “including,” and “includes” mean including, but not limited to.

Applicant has discovered and developed new technology which, given a piece of content in a document, such as a web page or a blog post, can automatically generate an original headline, or one or more alternative headlines to the original headline. The term “headline”, as used herein refers to any text that serves as topical indicator of the content, such as article headlines, subject lines of email messages, chapter names, or other headers in a document.

Headline can also refer to titles and sub-titles in a document. For example, the methods described herein can be used to generate a new sub-title or an alternative sub-title for each sub-section of text in a document. In this case, each sub-section of text can be processed separately using the described methods and systems to generate the sub-titles, even for sub-sections where the author did not originally have a sub-title. The generated sub-titles can then be used as a synopsis for the entire document (for example, by collapsing the text of the document to just the sub-titles).

Headline, as used herein, can also refer to a portion of the text which is designed to attract a reader's attention but is not necessarily at the top of an article or document, such a snippet of text which is enlarged and presented alongside an article. For example, magazines and online articles sometimes take snippets of an article and blow them up larger—this is aimed at grabbing the attention of a reader or potential reader and pulling them into the article. The methods and systems described herein can be used to generate new or alternative snippets for articles and other documents.

The headline generation methods and systems described herein can also be utilized to provide feedback or grades to authors and editors (such as by incorporation into the editing environment or content management system) and to suggest possible headlines or score suggested headlines before the article is even published. For example, an author or editor could suggest a headline for an article and the methods described herein can be used to score the suggested headline and indicate whether there are other possible headlines (based on the text of the document) with higher scores. This feedback can be used by the author or editor to reformulate the headline and/or improve future headlines.

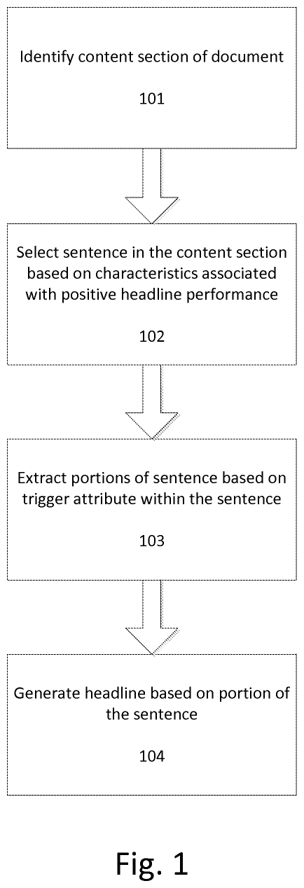

FIG. 1 is flowchart showing a method for generating headlines for a digital document according to an exemplary embodiment. The digital document can be any item of digital content, such as an article, a web page, a blog post, an email message, or any other digital content. If the digital document includes a video or audio clip, audio-to-text processing can optionally be performed on the content of the video or audio clip prior to performing the following steps in order to generate a body of textual content corresponding to the audio content in the audio clip or video.

At step 101, a content section of the document is identified. Identifying the content section can include isolating the zones or sections of the document which are applicable to the headline, since not all of the document sections are necessarily applicable.

In a digital document, such as a web page, some sections are ads, some sections are listings of other articles published that day which have nothing to do with the headline, some sections contain the copyright notices of the publisher, some sections are navigation menus, etc. Since the main body of text in the document is used as the raw material for new headlines, it is important to properly identify the content section of the document to make sure that extraneous or irrelevant content is not used to generate headlines.

This section can be identified through a variety of methods. For example, the content section can be identified based on the layout of the document and pre-existing rules regarding the likely location of the content section. In another example, the content section can be identified by analyzing the text of the document and comparing it to the original headline to identify which section of the document contains overlap with the original headline. The content section can also be identified by a purely textual analysis, such by counting the number of words or sentences in each section. Additionally, the content section can be identified based on syntax or grammatical features. For example, a section with complete sentences and multiple paragraphs can be flagged as a content section while a section with short or incomplete sentences, multiple images, multiple links, and/or little text can be identified as a non-content section, such as an advertisement section or a related article section. Of course, more than one section in the document can be identified as a content section.

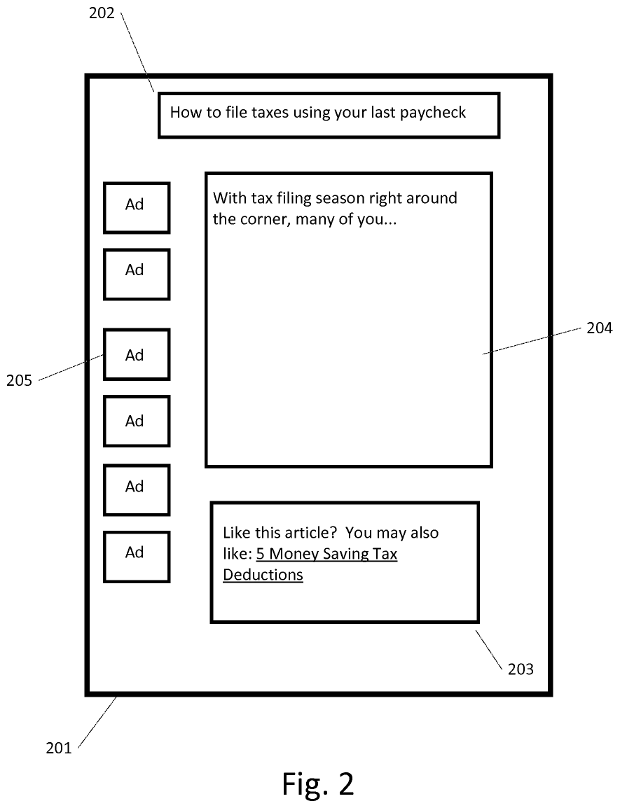

FIG. 2 illustrates a document 201 which is an article relating to filing taxes. The document 201 includes a headline section 202, a section with links to additional articles 203, a content section 204 which includes the body of the article, and multiple ads such as ad 205. In this example, section 204 can be identified as the content section using any of the above-described techniques. For example, the occurrence of complete sentences and paragraphs in section 204, along with the occurrence of the word “tax,” may result in that section being designated as a content section.

Returning to FIG. 1, at step 102, a sentence in the content section is selected based at least in part on a determination that the sentence exhibits one or more characteristics correlated with headline performance. This sentence can then be used to generate the headline. Of course, multiple sentences in the content section can also be selected from the content section and used to generate the headline (or multiple alternative headlines) based at least in part on a determination that the sentences exhibit one or more characteristics associated or correlated with headline performance.

Headline performance can be measured by a performance indicator such as click-through rate (CTR), conversion to action, time spent on site, and/or download rate. Performance indicators can include any metric which measures user engagement. For example, a performance indicator can be a mouse-over rate, which is the rate at which users move the mouse over a particular item. In another example, if an item (such as a link) on web page includes a quick survey/poll or other interactive user interface element, the performance indicator can measure how often users click a poll response or interact with the user interface element.

User engagement can be measured by any actions the user takes with regard to an item, such as a headline, that indicate the user is engaging with a page containing the item. For example, if a headline contains a link to a document and a small blurb from the document, a performance indicator can include detecting how often users scroll down a web page to read the headline and/or blurb.

When selecting a sentence in a document (or multiple sentences in a document) the characteristics considered can be those which correlate to positive headline performance or negative headline performance.

Characteristics correlated with positive headline performance can mean characteristics correlated with headlines that have a performance indicator above a predetermined threshold. For example, characteristics associated with headlines that have a CTR greater than 0.02% may be considered characteristics associated with positive headline performance.

Characteristics correlated with negative headline performance can mean characteristics correlated with headlines that have a performance indicator below a predetermined threshold. For example, characteristics associated with headlines that have a CTR less than 0.001% may be considered characteristics associated with negative headline performance.

Additionally, characteristics can be weighted according to the degree they are correlated with positive or negative headline performance. For example, the weights can be negative or positive, reflecting whether the characteristic is correlated with negative headline performance or positive headline performance.

For example, headlines starting with the word “Tips” can be correlated with a low CTR. As a result, any sentences starting with the word “tips” would have that characteristic be negatively weighted when computing a score for the sentence, as will be described further.

The one or more characteristics can include semantic characteristics (such characteristics having to do with meaning or topic) and grammatical characteristics (such as characteristics relating to how a sentence is written without regard to specific subject matter). Both kinds of characteristics may be desirable with regard to performance indicators such as CTR. Additionally, a characteristic can also be the existence of one or more particular words or phrases in the sentence.

An example of semantic characteristics can be sex, privacy, scandal, Edward Snowden, etc. These semantic characteristics can change over time (such as monthly, daily, or hourly). These are not keywords but topics which can be represented by many variations in phrasing. For example, the “privacy” topic can include sub-topics or associated terms such as “intrusion” or “fourth amendment.”

Additionally, certain topics can be more strongly associated with headline performance (and positive performance indicators), and the strength of that association can wax and wane over time.

Another sort of semantic characteristic would be high-level abstract characteristics such as, implied grade-level of vocabulary used in the sentence (for example whether a 12th grade or 4th grade level vocabulary is used). This characteristic can be determined or estimated based on how many words are used that are typical of readers at higher or lower grade levels. For example, if the word “sophistry” is correlated only with readers at an 11th grade level or higher, then a sentence containing the word “sophistry” can have an implied grade-level of 1 lth grade (assuming no major inconsistencies with other words in the sentence). Furthermore, if there is a correlation between low CTRs (such as CTRs below 0.0005%) and sentences written at grade-levels higher than 8th grade level, then this characteristic can be negatively weighted when the score for the sentence is determined.

Grammatical characteristics can include characteristics such as the use of one-digit natural numbers, or use of the number “five,” or use of any comparatives or superlatives, or use of particular superlatives such as “ugliest,” or use of certain prefatory words such as “tips” or “how to.” These characteristics can be general or specific, and can also be weighted.

A general characteristic can reference an entire class of words or constructions, such as “positive comparatives.” That includes phrases such as “better, faster, stronger, easier, smarter, more intelligent,” etc. A specific characteristic can be “equivalents of ‘faster,’” which can include “faster, quicker, speedier,” etc.

Additionally, grammatical characteristics can include a number or type of phrases in a sentence, a number of words, a number of punctuation marks, an average word length in characters or syllables, a number of connectives (such as and, but, it, not), sentence structure, parts-of-speech for each of the words, or any other grammar related characteristics.

Additionally, the system can receive input based on historical performance indicators, such as historical CTR data associated with particular headlines, to tailor the process by favoring characteristics, semantic or grammatical, that have been correlated with better performing headlines.

In this way, the optimization can be specific to real human behavior on a specific content network, which can differ from one audience to the next. This also means the headlines can be constructed differently than, for example, headlines constructed for Search Engine Optimization. For example, if the goal of the headlines is to increase the rate at which certain articles are forwarded or shared by users (such as in a social network), then the characteristics which are historically correlated with headlines for articles having a high rate of sharing can be positively weighted, resulting in headlines intended to optimize sharing of the article.

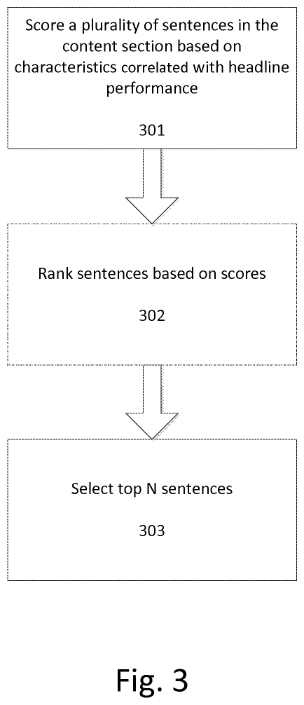

FIG. 3 illustrates a method for selecting sentences in the content section according to an exemplary embodiment. At step 301 a plurality of sentences in the content section(s) are scored based at least in part on the one or more characteristics associated with headline performance. Each sentence can be scored based on the occurrence of the one or more characteristics within that sentence. This scoring can be weighted as described above, and the weights and/or scores associated with each characteristic in the sentence can be aggregated to calculate a total aggregate score for each sentence in the content section.

For example, the characteristics can be weighted separately by class of characteristic, such that grammatical characteristics are weighted less than semantic characteristics, such as at a 2:3 ratio. So if a particular sentence includes one negative grammatical characteristic (meaning a characteristic correlated with poor headline performance) with a score of −5 and one positive semantic characteristic with a score of +3, then the total score for the sentence would be 2*(−5)+3*(+3)=−10+9=−1, since both types of characteristics are weighted.

Of course, the scores for each of the sentences can also be determined based on a score associated with each characteristics in the sentence, without any separate weighting of each characteristic. For example, if a sentence includes two positive characteristics with scores of 3, and 4.2, and one negative characteristic with a score of −1.2, then the total score for the sentence can be 3+4.2−1.2=6.

At step 302, the sentences in the content section(s) can optionally be ranked according to the assigned scores. This step can also be omitted. For example, if only one sentence is being selected to generate a headline, then this step can be omitted and the highest scoring sentence can be selected.

At step 303, the top N sentences in the content section(s) are selected as the seed sentences from which to construct one or more headlines, where N is any positive number less than or equal to the total number of sentences in the content section(s). For example, one sentence can be selected, five sentences can be selected, or ten sentences can be selected. The number of sentences selected can also be based on a score threshold. For example, all sentences which have a total score greater than a predetermined amount, such as an amount provided by the user, can be selected. After the sentence(s) are selected, the relevant portions of each of the sentence(s) are extracted.

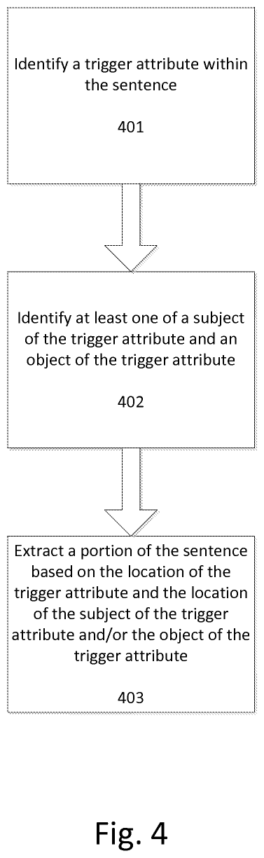

FIG. 4 illustrates a method for extracting a portion of a sentence in the content section according to an exemplary embodiment. At step 401 a trigger attribute is identified within the sentence. For example, the trigger attribute can be a verb or an adjective in the sentence. The trigger attribute can be identified based on an analysis of the grammatical and syntactical structure of the sentence. Additionally, the trigger attribute can be identified based on previous attributes that are correlated with positive headline performance. For example, if a certain adjective or verb is correlated with a high CTR, then that adjective or verb can be selected as the trigger attribute in the sentence. Alternatively or additionally, all of the possible trigger attributes in each sentence can be assessed and one can be selected based on a comparison with the original headline of the document, such that an alternative headline does not deviate too greatly in content.

At step 402 at least one of a subject of the trigger attribute and an object of the trigger attribute are identified. The subject of the trigger attribute and/or the object of the trigger attribute can be identified based on rules relating to at least one of syntax, grammar, parts-of-speech, and punctuation. This can include analyzing the sentence grammatically, left and right of the trigger attribute, to determine a “window” within which a complete concept (such as a verb with object and/or subject nouns) is likely expressed. Syntax parsing and punctuation can be used to determine this window. For example, commas often delimit segments of a longer sentence in a way that encapsulates a particular concept and commas can be used to separate the sentence into portions and thereby select the portion containing the trigger attribute.

At step 403 a portion of the sentence is extracted based at least in part on the location of the trigger attribute and the location of at least one of the subject of the trigger attribute and the object of the trigger attribute. For example, a portion of the sentence can be extracted that includes the trigger attribute and at least one of the subject of the trigger attribute and the object of the trigger attribute and any words between, while leaving out any words not located between. The extracted portion can be the earlier determined window as described above.

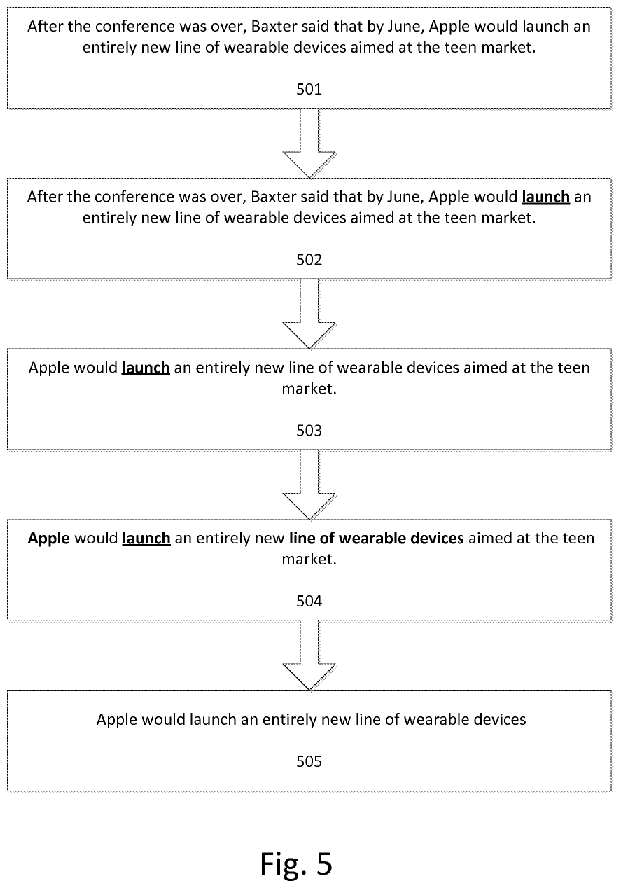

FIG. 5 illustrates an example of the process for extracting a portion of a sentence according to an exemplary embodiment. The initial sentence 501 contains three distinct portions, separated by commas. The sentence of 502 illustrates that the word “launch” is identified as the trigger attribute. This trigger attribute can be identified as described above. For example, all of the verbs in the sentence (said, launch, aimed) can be identified and one of the verbs can be selected based on a determination that it is most strongly correlated with positive headline performance. Alternatively, the text of the sentence can be compared with the original headline to find an overlap of terms, such as adjectives or verbs.

As shown in sentence 503 the sentence is concatenated based on the positions of the commas and the location of the trigger attribute so that we are left with the portion containing the trigger attribute.

As indicated in sentence 504, “Apple” is identified as the subject of the verb “launch” and “new line of wearable devices” is identified as the object of the verb “launch.” These identifications can be made based on rules relating to at least one of syntax, grammar, parts-of-speech, and punctuation as described above. For example, “Apple” can be identified as the subject since it is the immediately preceding noun phrase and “line of wearable devices” can be identified as the object since it is the immediately succeeding noun phrase.

Therefore, the beginning of the window for the portion of the sentence is the word “Apple” and the end of the window is the word “devices.” All of the words in this window are extracted, leaving the portion of the sentence shown at 505.

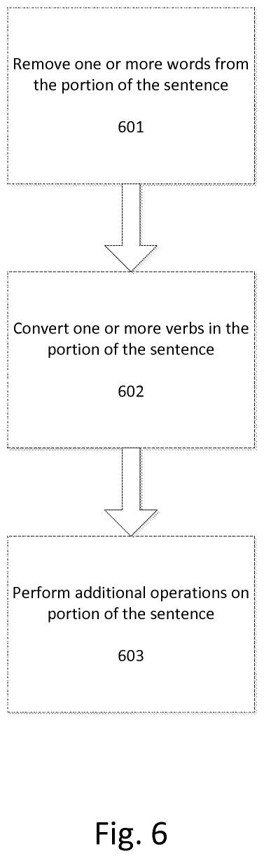

FIG. 6 illustrates the steps that can be performed on the portion of the sentence to generate the headline (or alternative headline) according to an exemplary embodiment. One or more of these steps can be performed to generate the headline. Alternatively, it is possible that the sentence portion does not require any further processing and none of the steps are required to be performed, in which case the sentence portion would be the headline.

At step 601, one or more words are removed from the portion of the sentence. The one or more words can include unnecessary adjectives, adverbs, and/or prepositional phrases. However, not all unnecessary adjectives, adverbs, and/or prepositional phrases are deleted. The determination of which words are deleted can be based on the desirability of each of the words in a final headline. In other words, if certain adjectives, adverbs, and/or prepositional phrases are correlated with positive headline performance, then they can be kept in the sentence portion. Otherwise, any words that are not logically and/or grammatically necessary to convey the concept of the sentence portion can be deleted.

At step 602, one or more verbs can be converted into a different tense. For example, a verb can be converted into an active tense or a gerund. Of course, other tenses can be used and these examples are provided for illustration only. A verb can be converted into any tense that is correlated with positive headline performance. For example, if the past tense of a particular verb has a greater correlation with positive headline performance, then that verb can be converted into past tense.

At step 603, one or more additional operations can be performed on the sentence portion to generate the alternative headline. These additional operations can include, for example, reordering of words in the portion of the sentence or addition of connectives between words in the sentence portion.

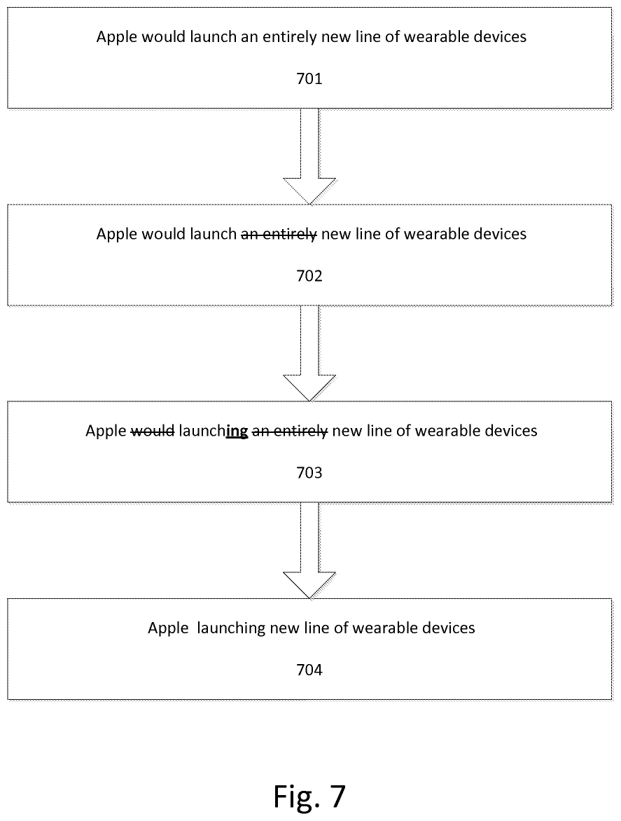

FIG. 7 illustrates an example of the process for generating a headline (or an alternative headline) from a portion of a sentence according to an exemplary embodiment. Portion 701 illustrates the portion of the sentence resulting from the extraction process shown in FIG. 5.

As shown in portion 702 the words “an entirely” are removed as being unnecessary. Of course, if any of these words were correlated with positive headline performance, then they could be kept. For example, if the word “new” was considered unnecessary (since, for example, “launch” already implies a new product) but the word “new” was correlated with positive headline performance, then it would not be removed. Furthermore, additional words can also be removed. For example, the prepositional phrase “of wearable devices” could also be removed for a shorter headline.

As shown in portion 703, the verb “launch” is converted into present tense and the previous word “would” is accordingly removed as no longer necessary or grammatically correct. After these changes are implemented, the headline 704 reads “Apple launching new line of wearable devices.”

One or more alternative headlines can be generated for an original headline using the processes described above. The one or more alternative headlines can be based on one or more sentences in the content portion of document, thereby utilizing the author's own words to generate the alternative headlines. The one or more alternative headlines can be rotated as the headline for the document and the results (in terms of performance indicators such as CTR) can be recorded for each alternative headline. Based on these results, a winning alternative headline can be selected from the one or more alternative headlines to permanently replace the original headline.

When generating an alternative headline, a score can be generated for the original headline using the sentence scoring processes described earlier, and the score for the original headline can be compared to that of the generated alternative headline to determine the improvement. Optionally, only alternative headlines that improve the score from the original headline by a predetermined threshold can be utilized or suggested to replace the original headline.

Additionally, the method for generating alternative headlines described above can also be utilized to generate original headlines. In this case, documents without headlines can be received and the processes described above can be used to identify the content section of the documents, identify one or more sentences as seed sentences, extract one or more portions from the seed sentences, and generate one or more possible headlines for the document.

Furthermore, as discussed earlier, the methods and systems for generating headlines described herein can be to generate sub-titles for sub-sections of text in a document or snippets of text to be enlarged or presented alongside an article or document or sections of a document. For example, a separate snippet or sub-title can be generated for each sub-section of text in a document based on the text in that sub-section. Additionally, as described earlier, the sentence scoring processes can be used to grade headlines suggested by authors or editors in pre-publication setting and the headline generation process can be used to provide possible alternative headlines with higher scores.

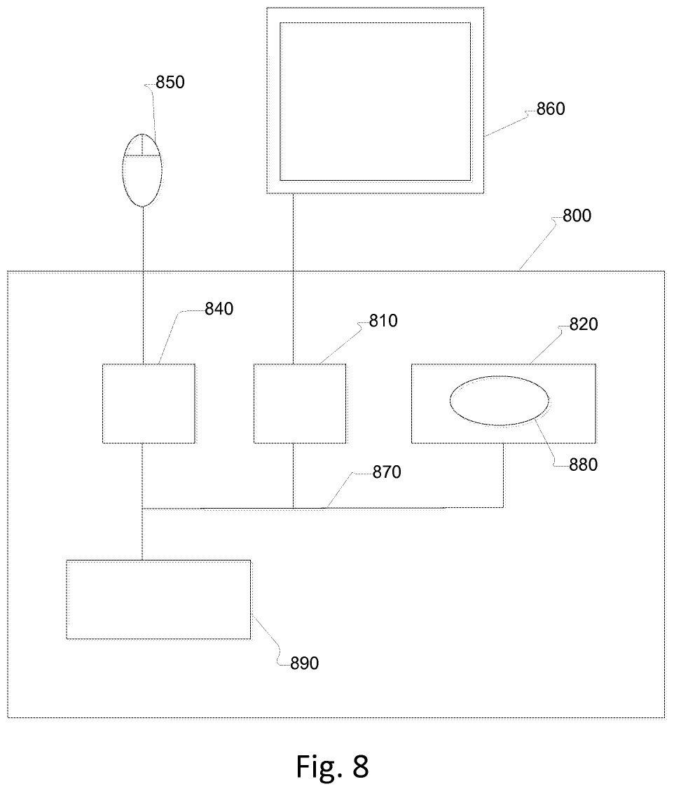

One or more of the above-described techniques can be implemented in or involve one or more computer systems. FIG. 8 illustrates a generalized example of a computing environment 800. The computing environment 800 is not intended to suggest any limitation as to scope of use or functionality of a described embodiment.

With reference to FIG. 8, the computing environment 800 includes at least one processing unit 810 and memory 820. The processing unit 810 executes computer-executable instructions and may be a real or a virtual processor. In a multi-processing system, multiple processing units execute computer-executable instructions to increase processing power. The memory 820 may be volatile memory (e.g., registers, cache, RAM), non-volatile memory (e.g., ROM, EEPROM, flash memory, etc.), or some combination of the two. The memory 820 may store software instructions 880 for implementing the described techniques when executed by one or more processors. Memory 820 can be one memory device or multiple memory devices.

A computing environment may have additional features. For example, the computing environment 800 includes storage 840, one or more input devices 850, one or more output devices 860, and one or more communication connections 890. An interconnection mechanism 870, such as a bus, controller, or network interconnects the components of the computing environment 800. Typically, operating system software or firmware (not shown) provides an operating environment for other software executing in the computing environment 1000, and coordinates activities of the components of the computing environment 800.

The storage 840 may be removable or non-removable, and includes magnetic disks, magnetic tapes or cassettes, CD-ROMs, CD-RWs, DVDs, or any other medium which can be used to store information and which can be accessed within the computing environment 800. The storage 840 may store instructions for the software 880.

The input device(s) 850 may be a touch input device such as a keyboard, mouse, pen, trackball, touch screen, or game controller, a voice input device, a scanning device, a digital camera, remote control, or another device that provides input to the computing environment 800. The output device(s) 860 may be a display, television, monitor, printer, speaker, or another device that provides output from the computing environment 800.

The communication connection(s) 890 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 800, computer-readable media include memory 820, storage 840, communication media, and combinations of any of the above.

Of course, FIG. 8 illustrates computing environment 800, display device 860, and input device 850 as separate devices for ease of identification only. Computing environment 800, display device 860, and input device 850 may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing environment 800 may be a set-top box, mobile device, personal computer, or one or more servers, for example a farm of networked servers, a clustered server environment, or a cloud network of computing devices.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments may be used with or perform operations in accordance with the teachings described herein. Elements of the described embodiment shown in software may be implemented in hardware and vice versa.

In view of the many possible embodiments to which the principles of our invention may be applied, we claim as our invention all such embodiments as may come within the scope and spirit of the following claims and equivalents thereto.

1. A method executed by one or more computing devices for generating a headline, the method comprising:
identifying, by at least one of the one or more computing devices, a content section of a document;
selecting, by at least one of the one or more computing devices, a sentence in the content section based at least in part on a determination that the sentence, separated from the text, is likely to attract users' attention based on historical performance indicators on a specified content network;
extracting, by at least one of the one or more computing devices, a portion of the sentence based at least in part on a trigger attribute correlated with positive headline performance within the sentence; and
generating, by at least one of the one or more computing device, the headline based at least in part on the portion of the sentence.

2. The method of claim 1, wherein the one or more characteristics correlated with headline performance comprise at least one of semantic characteristics and grammatical characteristics.

3. The method of claim 1, wherein headline performance is measured by a performance indicator.

4. The method of claim 3, wherein the performance indicator comprises at least one of click-through rate, conversion to action, time spent on site, and download rate.

5. The method of claim 1, wherein selecting a sentence comprises:
scoring a plurality of sentences in the content section based at least in part on the one or more characteristics correlated with headline performance, wherein each sentence is scored based on the occurrence of the one or more characteristics within that sentence; and
selecting the sentence in the plurality of sentences based at least in part on the score of the sentence.

6. The method of claim 1, wherein extracting a portion of the sentence comprises:
identifying the trigger attribute within the sentence;
identifying at least one of a subject of the trigger attribute and an object of the trigger attribute; and
extracting the portion of the sentence based at least in part on the location of the trigger attribute and the location of at least one of the subject of the trigger attribute and the object of the trigger attribute.

7. The method of claim 6, wherein at least one of the subject of the trigger attribute and the object of the trigger attribute are identified based on rules relating to at least one of syntax, parts-of-speech, grammar, and punctuation.

8. The method of claim 6, wherein the trigger attribute comprises at least one of a verb and an adjective.

9. The method of claim 1, wherein generating the headline comprises:
removing one or more words from the portion of the sentence.

10. The method of claim 9, wherein the one or more words comprise at least one of an adjective, an adverb, and a prepositional phrase.

11. The method of claim 1, wherein generating the headline comprises:
converting a verb in the portion of the sentence into either an active tense or a gerund.

12. An apparatus for generating a headline comprising:
one or more processors; and
one or more memories operatively coupled to at least one of the one or more processors and having instructions stored thereon that, when executed by at least one of the one or more processors, cause at least one of the one or more processors to:
identify a content section of a document;
select a sentence in the content section based at least in part on a determination that the sentence, separated from the text, is likely to attract users' attention based on historical performance indicators on a specified content network;
extract a portion of the sentence based at least in part on a trigger attribute correlated with positive headline performance within the sentence; and
generate the headline based at least in part on the portion of the sentence.

13. The apparatus of claim 12, wherein the one or more characteristics correlated with headline performance comprise at least one of semantic characteristics and grammatical characteristics.

14. The apparatus of claim 12, wherein headline performance is measured by a performance indicator.

15. The apparatus of claim 14, wherein the performance indicator comprises at least one of click-through rate, conversion to action, time spent on site, and download rate.

16. The apparatus of claim 12, wherein the instructions that, when executed by at least one of the one or more processors, cause at least one of the one or more processors to select a sentence further cause at least one of the one or more processors to:
score a plurality of sentences in the content section based at least in part on the one or more characteristics correlated with headline performance, wherein each sentence is scored based on the occurrence of the one or more characteristics within that sentence; and
select the sentence in the plurality of sentences based at least in part on the score of the sentence.

17. The apparatus of claim 12, wherein the instructions that, when executed by at least one of the one or more processors, cause at least one of the one or more processors to extract a portion of the sentence further cause at least one of the one or more processors to:
identify the trigger attribute within the sentence;
identify at least one of a subject of the trigger attribute and an object of the trigger attribute; and
extract the portion of the sentence based at least in part on the location of the trigger attribute and the location of at least one of the subject of the trigger attribute and the object of the trigger attribute.

18. The apparatus of claim 17, wherein at least one of the subject of the trigger attribute and the object of the trigger attribute are identified based on rules relating to at least one of syntax, parts-of-speech, grammar, and punctuation.

19. The apparatus of claim 17, wherein the trigger attribute comprises at least one of a verb and an adjective.

20. The apparatus of claim 12, wherein the instructions that, when executed by at least one of the one or more processors, cause at least one of the one or more processors to generate the headline further cause at least one of the one or more processors to remove one or more words from the portion of the sentence.

21. The apparatus of claim 20, wherein the one or more words comprise at least one of an adjective, an adverb, and a prepositional phrase.

22. The apparatus of claim 12, wherein the instructions that, when executed by at least one of the one or more processors, cause at least one of the one or more processors to generate the headline further cause at least one of the one or more processors to convert a verb in the portion of the sentence into either an active tense or a gerund.

23. At least one non-transitory computer-readable medium storing computer-readable instructions that, when executed by one or more computing devices, cause at least one of the one or more computing devices to:
identify a content section of a document;
select a sentence in the content section based at least in part on a determination that the sentence, separated from the text, is likely to attract users' attention based on historical performance indicators on a specified content network;
extract a portion of the sentence based at least in part on a trigger attribute correlated with positive headline performance within the sentence; and
generate a headline based at least in part on the portion of the sentence.

24. The at least one non-transitory computer-readable medium of claim 23, wherein the one or more characteristics correlated with headline performance comprise at least one of semantic characteristics and grammatical characteristics.

25. The at least one non-transitory computer-readable medium of claim 23, wherein headline performance is measured by a performance indicator.

26. The at least one non-transitory computer-readable medium of claim 25, wherein the performance indicator comprises at least one of click-through rate, conversion to action, time spent on site, and download rate.

27. The at least one non-transitory computer-readable medium of claim 23, wherein the instructions that, when executed by at least one of the one or more computing devices, cause at least one of the one or more computing devices to select a sentence further cause at least one of the one or more computing devices to:
score a plurality of sentences in the content section based at least in part on the one or more characteristics correlated with headline performance, wherein each sentence is scored based on the occurrence of the one or more characteristics within that sentence; and
select the sentence in the plurality of sentences based at least in part on the score of the sentence.

28. The at least one non-transitory computer-readable medium of claim 23, wherein the instructions that, when executed by at least one of the one or more computing devices, cause at least one of the one or more computing devices to extract a portion of the sentence further cause at least one of the one or more computing devices to:
identify the trigger attribute within the sentence;
identify at least one of a subject of the trigger attribute and an object of the trigger attribute; and
extract the portion of the sentence based at least in part on the location of the trigger attribute and the location of at least one of the subject of the trigger attribute and the object of the trigger attribute.

29. The at least one non-transitory computer-readable medium of claim 28, wherein at least one of the subject of the trigger attribute and the object of the trigger attribute are identified based on rules relating to at least one of syntax, parts-of-speech, grammar, and punctuation.

30. The at least one non-transitory computer-readable medium of claim 28, wherein the trigger attribute comprises at least one of a verb and an adjective.

31. The at least one non-transitory computer-readable medium of claim 23, wherein the instructions that, when executed by at least one of the one or more computing devices, cause at least one of the one or more computing devices to generate the headline further cause at least one of the one or more computing devices to remove one or more words from the portion of the sentence.

32. The at least one non-transitory computer-readable medium of claim 31, wherein the one or more words comprise at least one of an adjective, an adverb, and a prepositional phrase.

33. The at least one non-transitory computer-readable medium of claim 23, wherein the instructions that, when executed by at least one of the one or more computing devices, cause at least one of the one or more computing devices to generate the headline further cause at least one of the one or more computing devices to convert a verb in the portion of the sentence into either an active tense or a gerund.
